(19) United States
(12) Patent Application Publication
(10) Pub. No.: US 2002/0078443 A1
(43) Pub. Date: Jun. 20, 2002

(54) Presentation preemption

(76) Inventors: Sanjay S. Gadkari, Portland, OR (US); Narm Gadiraju, Portland, OR (US)

Correspondence Address: Richard C. Calderwood, BLAKELY, SOKOLOFF, TAYLOR & ZAFMAN, LLP, 7th Floor, 12400 Wilshire Boulevard, Los Angeles, CA, 90025, US

(21) Appl. No.: 09/748,686

(22) Filed: Dec. 20, 2000

(51) Int. Cl. H04N 7/16; H04H 9/00; G09G 5/00; H04N 7/025; H04N 7/10

(52) U.S. Cl. 725/32; 725/22; 725/25; 345/732; 725/36

(57) ABSTRACT

A receiver accepts an announcement, and begins receiving a presentation. The receiver is free to ignore announcements for other presentations. The sender substitutes a second content and issues an announcement using the same identifying information as was in the announcement of the accepted presentation, but a new version number. The receiver then uses the second content, believing it to be an updated version of the same presentation. ATVEF is one suitable environment. Other embodiments are disclosed and claimed.

### BACKGROUND OF THE INVENTION

1. Technical Field of the Invention

The present invention relates generally to multiple data stream reception, and more specifically to a method for a sender to guarantee preemption of a first data stream by a second data stream at a receiver.

2. Background Art

The Advanced Television Enhancement Forum (ATVEF) has promulgated an “Enhanced Content Specification” version 1.1 r26 (hereinafter “the ATVEF spec”) which outlines a recommended standard by which data-enhanced television broadcasts may be authored, sent, and received. The ATVEF spec is available from http://www.atvef.com/library/spec1_{—}1a.html. It defines a set of content specifications that establish minimum requirements for receiver devices. It also defines a set of delivery specifications regarding transport of enhanced TV content. It further defines a set of specific bindings.

ATVEF presentations are announced via an announcement stream, their contents are contained in presentation streams, and their flow or execution is controlled via trigger streams.

ATVEF announcements are sent on a predetermined multicast port, and provide information to the receiver to enable the receiver to “tune” to a specific presentation; a presentation's announcements tell the receiver which ports contain the data and triggers for that presentation. A presentation may have multiple data and trigger streams associated with its “variants”. There may be separate variants for, as one example, different versions of the presentation having different transmission bandwidth requirements—one suitable for receivers connected over a slow modem, and one for receivers connected over a cable modem. As another example, there may be an English variant, a Spanish variant, and a Chinese variant, between which the user may choose.

An announcement stream may be thought of as containing a sequence such as the following, in which A1.i are announcements for presentation P1, A2.i are announcements for presentation P2, and so forth:

A1.l A1.1 A1.2 A2.1 A1.3 A2.1 A2.2 A3.1 A2.3 A2.3 A3.2 A1.4 A3.3 . . .

In this example, A1.3 is a newer version than A1.2 or A1.1 of the A1 announcement. Also in this example, there are repeated instances of some of the announcements, such as A1.1 and A2.3.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows an ATVEF sender according to this invention, in communication with an ATVEF receiver.

FIG. 2A shows two consecutive ATVEF presentations such as might be sent in the prior art.

FIG. 2B shows a modified ATVEF presentation according to this invention, guaranteeing preemption at the receiver.

FIG. 2C shows a modified ATVEF presentation, and when viewed in conjunction with FIG. 2B, illustrates nesting of preemption.

FIG. 3A shows a television displaying a video program and an ATVEF presentation, as in the prior art. FIG. 3A relates to FIG. 2A.

FIG. 3B shows a television displaying a video program and a preempting ATVEF presentation. FIG. 3B relates to FIG. 2B.

FIG. 3C shows a television displaying a video program and a nested preempting ATVEF presentation. FIG. 3C relates to FIG. 2C.

FIG. 4 illustrates a flowchart of the method of one embodiment of a system constructed according to this invention.

FIG. 5 illustrates a stylized computer control storage medium upon which is recorded instructions which, when executed, cause a computer to perform the method of operating one embodiment of a sender constructed according to this invention.

### DETAILED DESCRIPTION

This invention relates broadly to multiple data stream transmission, and allows a sender to guarantee that a receiver uses a second data stream, when the receiver had been using a first data stream and is generally constructed with the ability to ignore announcements concerning data streams. The invention will, for convenience, be described with detailed reference to an embodiment that is constructed to make use of the ATVEF specification. The skilled reader will, however, recognize that the invention is not limited to ATVEF, but has applicability in any technology where the receiver has a choice between two or more competing data streams and selects one for presentation based on an announcement stream that contains announcements which provide identifying and other information about each of the multiple data streams, allowing the receiver to differentiate between the data streams. The skilled reader will further understand that the invention is not limited to use in television.

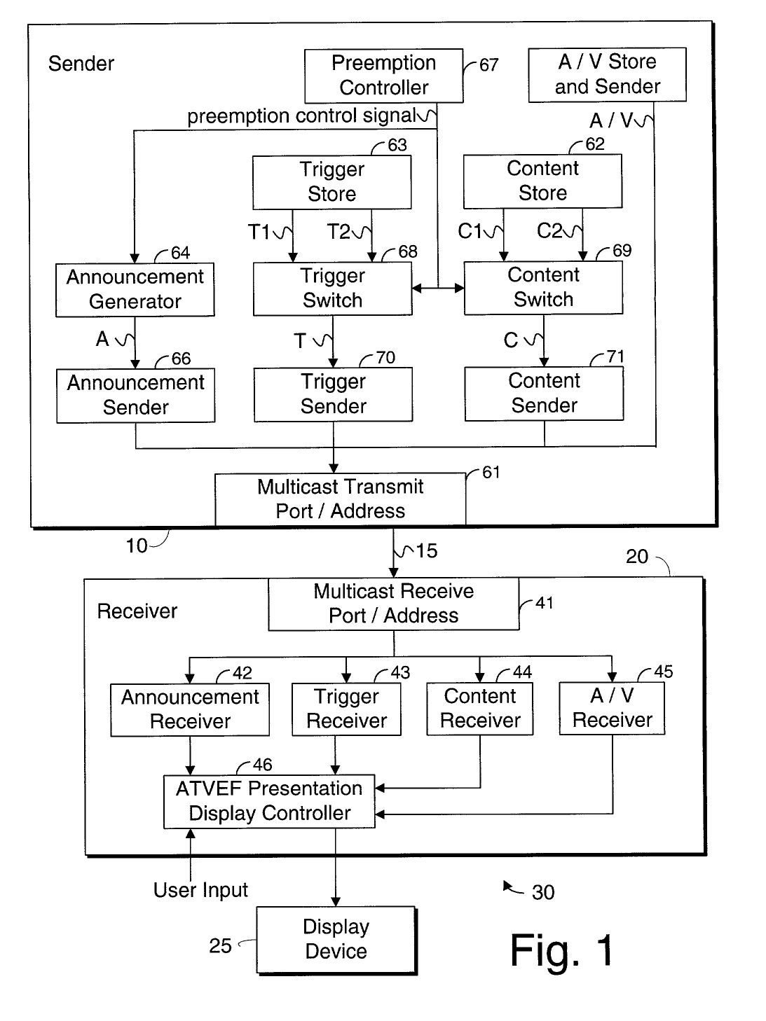

FIG. 1 illustrates an ATVEF sender 10 coupled over a communication link 15 to an ATVEF receiver 20 which is coupled to a display device 25. Together, this makes up an ATVEF system 30. The communication link 15 may be any suitable transport mechanism, such as over-air broadcast, cable, radio, laser, satellite, or the like. The display device 30 may be any suitable display mechanism, such as a cathode ray tube, plasma display, projection screen, liquid crystal display, holographic display, projector, or the like.

The receiver 20 is a conventional ATVEF receiver as known in the art as updated from time to time. The receiver includes a mechanism 41 for coupling to the communication link, and, in one embodiment, may include a multicast receive port and address mechanism. The receiver further includes an announcement receiver 42 for receiving ATVEF announcements, a trigger receiver 43 for receiving ATVEF triggers, and a content receiver 44 for receiving ATVEF content. The receiver further includes an audio/video (A/V) receiver 45 for receiving A/V content or the like. The receiver includes an ATVEF presentation display controller 46 which is responsively coupled to the announcement receiver, trigger receiver, content receiver, and A/V receiver, and may also be adapted to receive user input (such as via a remote control device or via an on-screen menu system, not shown).

The receiver typically includes a computing device with a processor and storage for data. A general purpose computer, such as a PC, may be purposed as an ATVEF receiver by appropriate software. Other programmable hardware, such as a PLA or FPGA or the like, may also be configured as a receiver via suitable input “instructions” or control codes.

When the user is watching a television program which is not ATVEF enhanced, or when the user has chosen to ignore an incoming ATVEF announcement, the ATVEF presentation display controller will simply pass the A/V content through from the A/V receiver to the display device.

However, when the user is watching a television program which is ATVEF enhanced, and the user has accepted an ATVEF announcement (or, alternatively, if the receiver has automatically accepted the ATVEF announcement), the ATVEF presentation controller will modify the on-screen (perhaps including audio) display to show the user the ATVEF content from the content receiver 44 as controlled by ATVEF triggers received by the trigger receiver 43. The ATVEF presentation is not necessarily visible; it may, for example, simply enable “hot spots” or hyperlinks on the display.

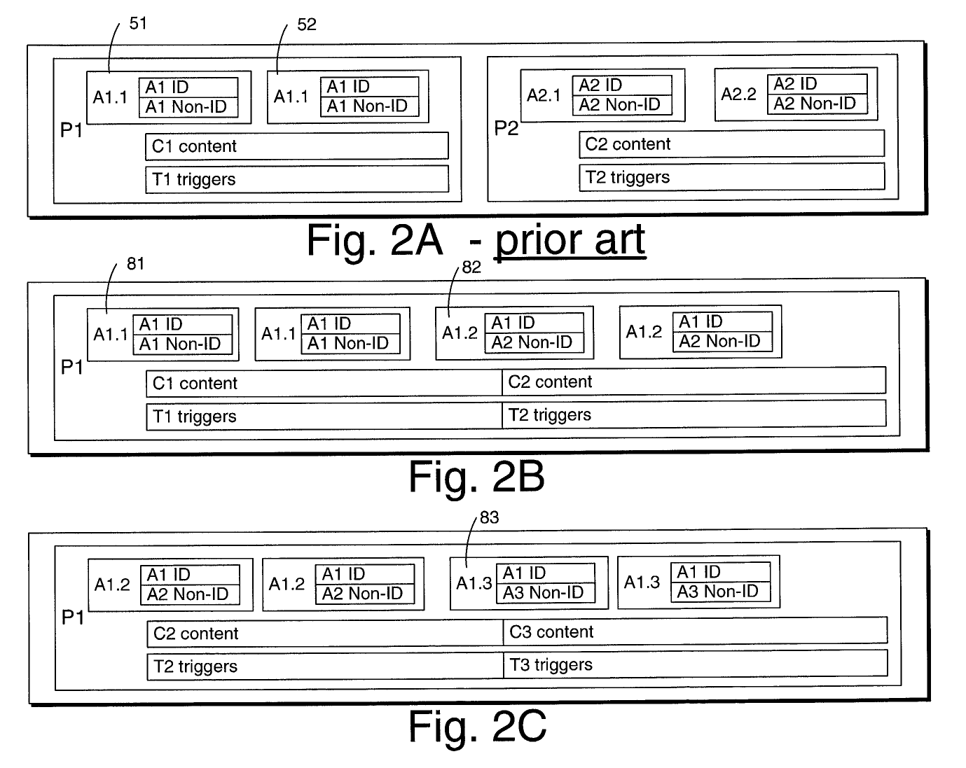

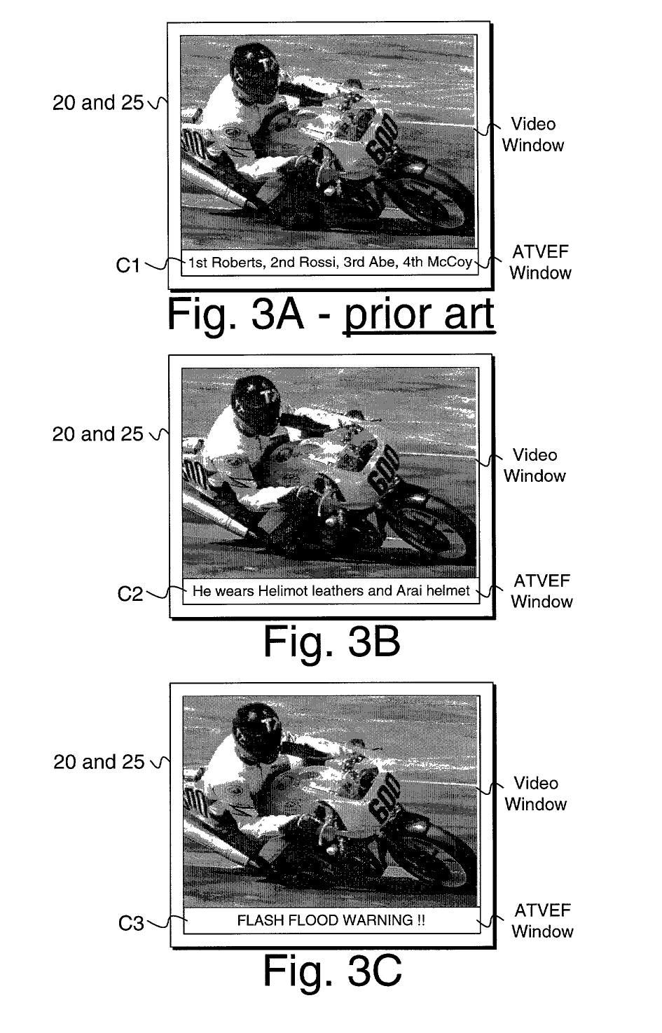

FIG. 2A illustrates a chronological sequence of ATVEF presentations (from left to right), and will be discussed with reference also to FIGS. 1 and 3A. The receiver 20 begins receiving a first ATVEF presentation P1 with the arrival of a first instance 51 of an ATVEF announcement A1 at the announcement receiver 42. The announcement includes information (A1 ID) which identifies the announcement to the receiver, and may also include additional information (A1 Non-ID) which does not serve as an identification of the announcement.

In one embodiment, constructed in accordance with the ATVEF specification v1.1 r26, the identifying information (A1 ID) includes the SDP Session ID (SID) and, optionally, the Session Name (the “s=” field). There are other fields which may optionally be used as identifying information, such as the Session Description (the “i=” field) and the “a=UUID:uuid” field; but some embodiments may not use these as identifying information, since these fields are not required by the ATVEF spec to be present.

The version number (part of the “o=” field) is related to the identifying information, but may in some embodiments not necessarily be construed as being part and parcel thereof. Per the ATVEF specification, receivers are free to ignore repeated instances of announcements which have the same session ID as an already-accepted announcement but have a version number that is not higher than the accepted version. The version number is related to the session ID, in that per the ATVEF specification, the receiver is free to ignore an announcement for an already-accepted presentation if the version number is less than or equal to the already-accepted version, but the receiver is supposed to accept new versions of an announcement for an already-accepted presentation.

In one embodiment, the non-identifying information (A1 Non-ID) may include other information such as the “high water mark” cache size, the expiration time, the required bandwidth, a new data port or trigger port, and so forth.

After the arrival of the first instance of the ATVEF announcement 51, there may be repeated instances of that same announcement (such as 52). Following the announcement, the contents Cl and triggers T1 of the first presentation P1 are received by the content receiver 44 and trigger receiver 43, respectively. The triggers may control, for example, the timing and duration of the display of chunks of the content. In the illustrative example shown in FIG. 3A, the A/V content is a broadcast of a motorcycle race which is shown in a video window on the display device 25, and the associated ATVEF presentation P1 includes content C1 which is a scrolling “ticker” which informs the viewer which racers are in which positions in the race. If the user had not accepted the announcement Al of this presentation P1, the ATVEF window would not be displayed, and the video window would be shown in the full screen.

One salient point is that, according to the ATVEF specification, receivers are not required to pay attention to incoming announcements, and are generally free to ignore them. If a receiver is already displaying a first ATVEF presentation, such as P1, the receiver 20 and the user are free to ignore announcements (such as A2) of subsequent presentations (such as P2). But it may be desirable for the sender 10 to “hijack” or preempt the ATVEF portion of the display, such as to insert a commercial announcement or the like.

FIG. 1 illustrates the sender 10 of this invention which is adapted to do this. The sender includes an output device or mechanism 61 for coupling to the communication link 15, and, in one embodiment, may include a multicast transmit port and address mechanism. The sender includes a content store 62 which stores the content of ATVEF presentations, a trigger store 63 which stores the corresponding ATVEF triggers for those ATVEF presentations, and an announcement generator 64 which generates ATVEF announcements for those ATVEF presentations. The sender also includes an A/V store 65 which stores the audio and visual content of television programs and the like. In some embodiments, the trigger store, content store, A/V store could be receivers which pass through content from external sources, or they could be generators which create new content on the fly. “Generate” may mean creation from scratch, retrieval from storage, retrieval from external sources, combination from multiple internal or external sources, or a hybrid thereof.

The announcement output (A) of the announcement generator is provided to an announcement sender 66 which delivers the announcement to the communication mechanism 61. The A/V output from the A/V store is provided to the communication mechanism.

The sender is further equipped with a preemption controller 67, a trigger switch 68, and a content switch 69. The trigger switch is coupled to a trigger sender 70, and the content switch is coupled to a content sender 71, which are, in turn, coupled to the communication mechanism 61.

FIGS. 1, 2A, and 3A-B illustrate the operation of the sender in preempting the ATVEF presentation at the receiver. As in the prior art, the sender has issued one or more instances (81) of announcement A1.1 of a presentation P1, and the receiver has accepted it and begun displaying the content C1 under control of the triggers T1 of the first presentation.

But rather than issue a different announcement (A2.1 in FIG. 2A), which the receiver would be free to ignore, the preemption controller 67 causes the announcement generator 64 to issue a second announcement A1.2 (82) which includes the same identifying information (A1 ID) that was in the first announcement A1 (81) of the first presentation P1, but a version identifier which indicates that the second announcement supercedes the first announcement. The announcement A1.2 may include non-identifying information (A2 Non-ID) which is different than the non-identifying information (A1 Non-ID) of the first announcement.

But rather than it simply being a new version of the same presentation, the preemption controller 67 causes the trigger switch 68 to select (and pass through to the trigger sender) a second presentation's triggers T2 from the trigger store instead of the first presentation's triggers T1, and causes the content switch 69 to select (and pass through to the content sender) a second presentation's content C2 from the content store instead of the first presentation's content C1.

As shown in FIG. 2B, the second presentation's content C2 and triggers T2 are treated by the receiver as though they were part of the first presentation P1, because the identifying information (A1 ID) in the new announcement A2 (82) from the announcement generator is the same as the identifying information (A1 ID) in the original announcement A1 (81). The receiver is tricked into accepting the new content C2 and new triggers T2 as though they were part of the presentation P1 that was accepted at announcement A1, because the identifying information is the same but the version number has been increased. The original presentation and the preempting presentation may together be regarded as a “combined presentation”.

FIGS. 2C and 3C illustrate that the preemption can be nested or repeated. While the preemptive, replacement content C2 with its triggers T2 are being displayed (such as to replace the original race position ticker from FIG. 3A with the commercial from FIG. 3B), the preemption controller can again kick in to cause the announcement generator to create a third announcement A1.3 which, again, reuses the identifying information (A1 ID) of the original, accepted announcement (A1 in FIG. 2B). The new announcement A1.3 (83) may include non-identifying information (A3 Non-ID) which is different than that of the second announcement A1.2 and/or the first announcement A1.1. The session ID/identifying information is reused, and, again, the version number is increased, causing the receiver to again re-examine the non-identifying information. The preemption controller causes the trigger switch and content switch (of FIG. 1) to select and pass through triggers and content (not shown in FIG. 1) for the third version of what the receiver believes to be the same, accepted presentation P1. As illustrated in FIG. 3C, a flash flood warning has preempted the commercial, which had preempted the race ticker.

In some cases, some portions of the non-identifying information may not need to change. For example, both the first content item and the second content item may use the same high water mark in the cache, or they may both use the same transmission bandwidth.

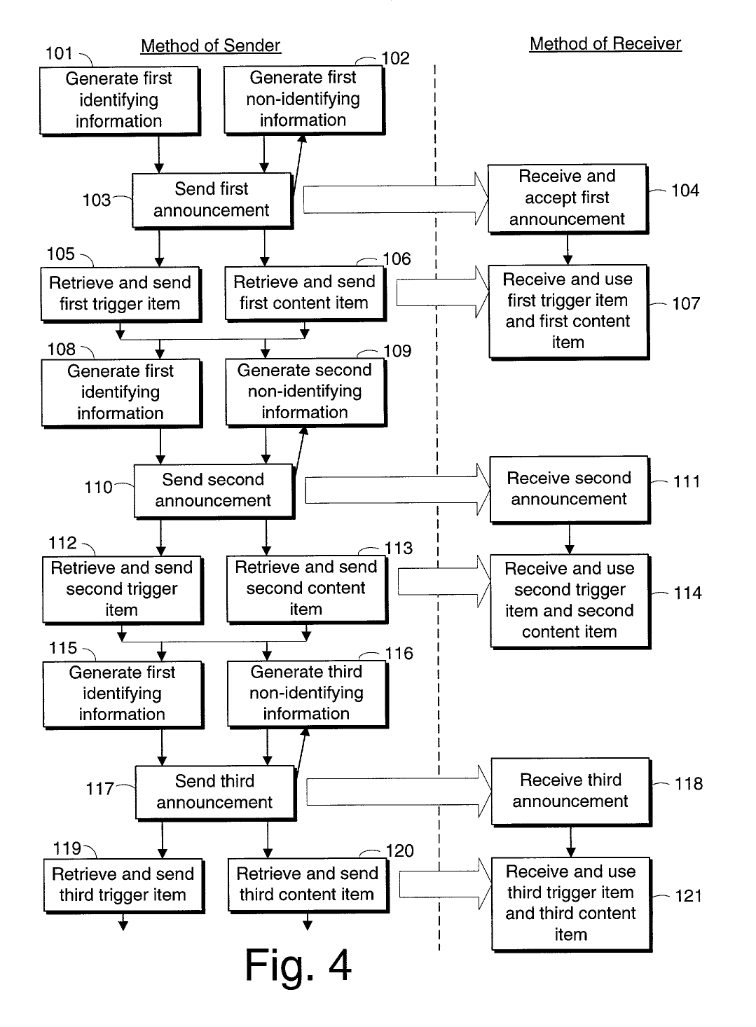

FIG. 4, specifically the left-hand side thereof, illustrates a method of operating one embodiment of a sender constructed according to the principles of this invention. The method will be described in terms of “steps”, but the reader will understand that the flowchart of FIG. 4 may also be interpreted as describing a series of operations, processes, computer routines, FPGA control codes, firmware, or the like. Please refer also to FIG. 1. The right-hand side of FIG. 4 illustrates the method of operation of a receiver in response to the items sent to it by a sender which performs the method illustrated on the left-hand side.

At step 101, the announcement generator 64 generates the identifying information of a first announcement, and generates a version number for the first announcement. At step 102, the announcement generator generates non-identifying information for the first announcement. At step 103, the announcement sender 66 sends the first announcement out through the communication mechanism 61 and onto the communication link 15. At step 104, the announcement receiver 42 of the receiver 20 receives and accepts the first announcement.

At step 105, the trigger switch 68 retrieves a first trigger item T1 from the trigger store 63 and forwards it to the trigger sender 70, which passes it out through the communication mechanism 61 and onto the communication link 15. At step 105, the content switch 69 retrieves a first content item C1 from the content store 62 and forwards it to the content sender 71, which passes it out through the communication mechanism 61 and onto the communication link 15. At step 107, the trigger receiver 43 and content receiver 44 of the receiver 20 receive the first trigger item and first content item, respectively, and the ATVEF presentation display controller 46 performs appropriate processing (such as decompression or visual formatting) on the content item, and, as governed by timing indicated in the trigger, causes the processed content item to be displayed on the display device 25.

At this point, the sender wishes to preempt the presentation presently being displayed at the receiver/display device. At step 108, the announcement generator generates identifying information which is functionally identical to the identifying information generated at step 101, either by regenerating the same information or by retrieving a stored copy of it. It does this under control of the preemption controller. By “functionally identical”, it is meant that e.g. if there are bits or bytes etc. which are not used by the receiver, their content may vary between the first and second announcements; for example, a three-byte session ID may be sent in a four-byte field, with the fourth byte being ignored. Also at step 108, a version number is generated for the second announcement, greater than the version number of the first announcement. At step 109, the announcement generator generates non-identifying information suitable for enabling the receiver to use the hijacking presentation content, such as cache size and bandwidth. At step 110, the second announcement, including the new non-identifying information and the repeated identifying information, is sent to the receiver. At step 111, the receiver receives and accepts the second announcement, believing it to be an updated version of the first announcement.

At steps 112 and 113, he preemption controller 67 manipulates the trigger switch 68 and the content switch 69 to cause the sender to retrieve and send a second trigger item and a second content item, respectively. At step 114, the receiver receives this preemptive content item, and, under control of the substitute trigger item, causes the display device to display the hijacking or preemptive content item.

At this point, the sender wishes to perform a nested preemption, in that it wishes to preempt the second content item. At steps 115 and 116, the preemption controller 67 again causes the announcement generator 64 to provide yet another copy of the first identifying information, a new version number greater than the second version number, and with third non-identifying content information. At step 117, this third announcement is sent to the receiver, which at step 118 again believes it to be an update to the first, accepted announcement, therefore accepting the third announcement.

At steps 119 and 120, the preemption controller causes the trigger switch and content switch to fetch third trigger and content items, respectively, and to send them to the receiver. At step 121, the receiver receives and utilizes the third content item under control of the third trigger item.

If triggers are not used in a particular embodiment, it will be understood that the trigger-related steps in FIG. 4 can simply be omitted. It will further be understood that in the case of redundant announcement generation and sending, the steps such as steps 102 and 103 can be iterated one or more times. For example, there may be repeated announcements for an upcoming presentation, in case a viewer tuned in after the first announcement was sent. Or, there may be repeated announcements in which the non-identifying information changes, such as to update the expiration date/time.

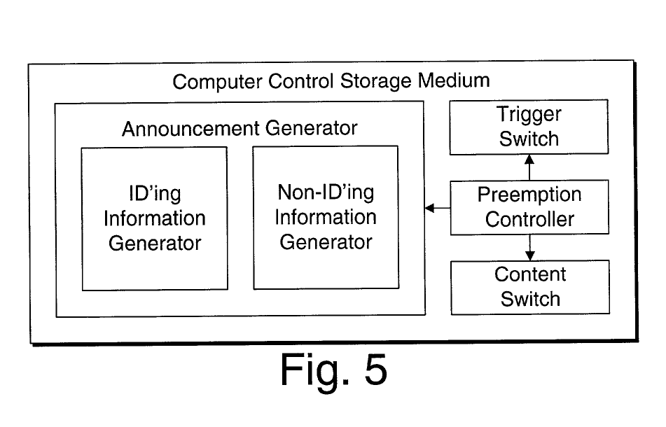

FIG. 5 illustrates, by way of stylized example, a machine-accessible mechanism which includes routines, programs, control codes, firmware, instructions, or the like (hereinafter simply “instructions” or “routines” for short), for carrying out one method of practicing this invention upon a sender. Please also make reference to FIG. 1. The skilled reader will readily appreciate that there are a wide variety of coding styles and formats within which this invention may be practiced, and that it is not necessary for items called out below as “routines” to actually be coded as conventional “subroutines” or the like. The skilled reader will further appreciate that this machine-accessible mechanism may be a recordable medium such as a floppy disk, a CD-ROM, a DVD disc, a tape, a semiconductor memory device, or that it may be embodied as, for example, packets of data carried by a transmission mechanism such as the internet, a local area network, a wireless broadcast, or the like.

The routines include an “Announcement Generator” routine which causes the sender to perform the functionality described above with regard to the announcement generator 64. The Announcement Generator routine includes an “ID-ing Information Generator” routine which generates the identifying information portion of announcements. In one embodiment, the ID-ing Information Generator routine may specify a particular multicast port and address for the announcement being generated, and may further specify a unique identifier value for the announcement. The Announcement Generator routine further includes a “Non-ID'ing Information Generator” routine which generates the non-identifying information portion of announcements. In one embodiment, the Non-ID'ing Information Generator routine may specify a high-water-mark cache size, a bandwidth, and an expiration date/time for the announcement being generated.

The routines also include a “Trigger Switch” routine which causes the sender to select between two or more possible trigger items, such as from a trigger store. The routines further include a “Content Switch” routine which causes the sender to select between two or more possible content items, such as from a content store; it should be understood that this refers not to A/V content, but, rather, to the content which, together with a trigger item and an announcement, make up a presentation. In one embodiment, this may be an ATVEF presentation.

Finally, the routines include a “Preemption Controller” routine, which functions as a master control routine over the Announcement Generator routine, the Trigger Switch routine, and the Content Switch routine. When the Preemption Controller routine wishes to hijack a presentation which has previously been accepted by a receiver, the Preemption Controller routine causes the ID'ing Information Generator routine to generate identifying information which is the same as identifying information which the ID'ing Information Generator routine had previously generated in the creation of the original (or at least the most recent) announcement which was sent for the presentation to be hijacked, as well as an updated version identifier. The Preemption Controller routine causes the Non-ID'ing Information Generator routine to generate non-identifying information which is not necessarily the same as the corresponding information in the original (or most recent) announcement for the presentation to be hijacked; this new non-identifying information will describe characteristics of the presentation as it will be after hijacking, such as a new high-water-mark cache size, a new bandwidth, and/or a new expiration date/time.

Then, after the Preemption Controller routine has caused the Announcement Generator routine to send out this new announcement (which the receiver will automatically accept, because the same identifying information is in the new announcement as was in the previously-accepted announcement), the Preemption Controller routine will cause the Trigger Switch routine to select the trigger item, and the Content Switch routine to select the content item, for the post-hijacking presentation.

The reader is referred now not to any specific drawings, but to the above teachings as a general whole. At the end of the preempting presentation's content, there are three basic options regarding what to do with the combined presentation. First, play may return to the original presentation at the point at which it was preempted; this may be termed “presentation time shifting”. Second, play may join the original presentation at a point where it would have been if there had been no preemption; this may be termed “trigger suppression” or “presentation override”. Or third, the combined presentation may be treated as having ended, with no return to the preempted presentation's content.

In the first case, presentation time shifting, file sends and triggers from the original presentation that were scheduled to occur during the time of interruption are postponed by the sender and time shifted to after the end of the interrupting presentation. Because the length of the interrupting presentation may not be known beforehand, the amount of time shift may need to be dynamically computed once the interrupting session expires or has been deleted.

In the second case, trigger suppression, triggers from the original presentation can simply be suppressed or ignored until the end of the interrupting presentation, when they may be resumed, while files from the original presentation scheduled for transmission at the same time continue to be transmitted in parallel, in order to allow the trigger stream from the original presentation to resume correctly after the interrupting presentation has terminated. In this approach, triggers from the original presentation that were scheduled to be sent during the interruption are simply discarded by the sender with the trigger stream resuming as if those triggers had already been sent. This is simpler to implement than the time shifting alternative, but is content-dependent, since a discarded trigger may be a dependency for a future trigger. For example, if a discarded trigger would have changed the base page, and subsequent triggers refer to a base page, the content intended for display following the interruption will never be triggered. Also, the time shifting embodiment may require extra storage on the receiver.

The third case is actually a special case of either of the other two. If the preempting presentation is appended to the end of the already-accepted presentation, the already-accepted presentation is not really preempted but is extended. If the preempting presentation is longer than the remaining portion of the preempted presentation, and trigger suppression is used, then the preempted presentation will simply have expired before the preempting presentation ends.

If the sender provides alternative, competing presentations between which the user or receiver may choose, the invention may be implemented by applying the methodology described above to each of the competing presentations. If, in the example given, the user has a choice of watching a race position ticker presentation (P1), or watching a presentation (say P4) showing a throttle position sensor output of a particular machine, or watching a presentation (say P5) showing the tachometer and speedometer readings of a particular machine, the sender may wish to interrupt all of those with a commercial presentation (say P6). To accomplish this, the sender sends an announcement (say A1′) which bears the same identifying information as the prior announcement for the race position ticker presentation but the non-identifying information of the commercial; the sender sends an announcement (say A4′) with the identifying information from the throttle position presentation's prior announcement and the commercial's non-identifying information; and the sender sends an announcement (say A5′) with the identifying information from the tachometer presentation's prior announcement and the commercial's non-identifying information. Regardless of which of the three presentations the receiver has accepted to view, the commercial content will preempt the desired content.

In the case of ATVEF “variants” (e.g. multiple content streams bearing the same content at different resolutions or bandwidth requirements, or, e.g. content streams in different languages), the presentation is announced with a single announcement stream with multiple content media streams defined at the media level of the announcements. If the sender wishes to uniformly preempt all of those variants, the preempting presentation may have a corresponding set of variants to preempt respective ones of the original presentation's variants. To accomplish this, the sender sends a modified announcement updating the version and specifying cache and bandwidth required to support all of the interrupting presentation variants.

While the ATVEF specification presently indicates that the receiver will display only one presentation at a time, this invention is not limited to that case. If a receiver is equipped to display multiple presentations at the same time, the principles of this invention are readily applied to such a system, allowing the sender to preempt all of them together, or to preempt only selected ones of them, at a time. The invention is also suitable for use in systems where the user may prevent

preemption of a subset of the displayed presentations. For example, the user may be willing to have the race position ticker interrupted periodically by commercials, but may be unwilling to have his stock price ticker preempted.

The invention is also not limited to the case where a trigger stream is required. In some embodiments, the triggers may be implicit, or may not be needed.

A presentation might be any form of content provision, whether data, video, audio, or whatever. In such a case, the user might be watching a primary channel, such as a basketball game, and the equivalent of the ATVEF presentation discussed in this patent may actually be a separate channel or presentation, such as a hockey game, being displayed e.g. in a small window in the corner of the television screen. If the content feed for this “presentation” is e.g. a live camera feed directly from the hockey arena, it may be commercially desirable for the sender to be able to periodically preempt that presentation with a commercial. Or, in another case, the presentation could be a minimized window showing only the score of the hockey game, and the preempting presentation content could be a larger window showing video of a goal being scored.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A method comprising:
(a) sending a first announcement including first identifying information;
(b) sending a first content item associated with the first announcement;
(c) sending a second announcement including the first identifying information; and
(d) sending a second content item associated with the second announcement.

2. The method of claim 1 wherein:
the first and second announcements comprise first and second ATVEF announcements, respectively; and
the first and second content items comprise first and second ATVEF announcements, respectively.

3. The method of claim 2 further comprising:
(e) sending a first ATVEF trigger item; and
(f) sending a second ATVEF trigger item.

4. The method of claim 1 wherein:
the (a) sending further comprises the first announcement further including first non-identifying information;
the (c) sending further comprising the second announcement further including second non-identifying information which is different from the first non-identifying information.

5. The method of claim 4 wherein:
the first and second announcements comprise first and second ATVEF announcements, respectively;
the first and second content items comprise first and second ATVEF announcements, respectively; and
the method further comprises,
(e) sending a first ATVEF trigger item, and
(f) sending a second ATVEF trigger item.

6. The method of claim 5 wherein the first announcement is a most up-to-date version of an announcement.

7. The method of claim 4 further comprising:
sending a plurality of variants of the first announcement each including same first identifying information and different variants of the first non-identifying information; and
sending a plurality of variants of the second announcement each including same first identifying information and different variants of the second non-identifying information.

8. The method of claim 1 further comprising:
including a first version identifier in the first announcement; and
including a second version identifier in the second announcement, the second version identifier being greater than the first version identifier to cause a receiver to accept the second content item.

9. A method for a sender to preempt content of a first presentation with a second content at a receiver, comprising:
the sender sending a first announcement which includes first identifying information and first non-identifying information;
the receiver accepting the first announcement;
the sender sending the content of the first presentation;
the receiver receiving the content of the first presentation and utilizing the content of the first presentation in accordance with having accepted the first announcement;
the sender sending a second announcement which includes the first identifying information and second non-identifying information;
the sender sending the second content; and
the receiver receiving the second content and utilizing the second content in accordance with having accepted the first announcement.

10. The method of claim 9 further comprising:
the sender sending a trigger of the first presentation;
the receiver receiving the trigger of the first presentation; and
the utilizing by the receiver of the content of the first presentation is performed under control of the trigger of the first presentation.

11. The method of claim 10 further comprising:
the sender sending a second trigger;
the receiver receiving the second trigger; and
the utilizing by the receiver of the second content is performed under control of the second trigger.

12. The method of claim 9 wherein the presentation is an ATVEF presentation.

13. The method of claim 12 further comprising:
the receiver operating according to a first value of an operational characteristic upon receiving the first announcement; and
the receiver operating according to a second value of the operational characteristic upon receiving the second announcement;
wherein the operational characteristic is selected from the group comprising,
cache size,
expiration time, and
bandwidth; and
wherein the first value of the operational characteristic is specified by the first non-identifying information, and the second value of the operational characteristic is specified by the second non-identifying information.

14. The method of claim 9 further comprising:
the sender sending a third announcement which includes the first identifying information and third non-identifying information;
the sender sending third content; and
the receiver receiving the third content and utilizing the third content in accordance with having accepted the first announcement.

15. The method of claim 14 further comprising:
upon the third content ending, the receiver returning to utilizing the second content; and
upon the second content ending, the receiver returning to utilizing the first content.

16. The method of claim 9 further comprising:
upon the second content ending, the receiver returning to utilizing the first content.

17. The method of claim 16 wherein the receiver returns to a point at which the first content was interrupted.

18. The method of claim 16 wherein the receiver returns to a point at which the first content would have been had the receiver not utilized the second content.

19. The method of claim 9 further comprising:
the sender including a first version identifier in the first announcement;
the sender including a second version identifier in the second announcement; and
the receiver utilizing the second content because,
the second announcement includes the same identifying information as the first announcement, and
the second announcement's version identifier indicates that the second announcement supercedes the first announcement.

20. A method of sending an ATVEF presentation comprising:
generating a first ATVEF announcement including first identifying information and first non-identifying information;
sending the first ATVEF announcement;
sending a first ATVEF content item and a first ATVEF trigger item;
generating a second ATVEF announcement including the first identifying information and second non-identifying information;
sending the second ATVEF announcement; and
sending a second ATVEF content item and a second ATVEF trigger item.

21. The method of claim 20 wherein:
the first identifying information comprises a multicast address and port, and an ATVEF announcement identifier.

22. The method of claim 20 further comprising:
including in the first ATVEF announcement a first version identifier; and
including in the second ATVEF announcement a second version identifier indicating that the second ATVEF announcement supercedes the first ATVEF announcement.

23. The method of claim 20 further comprising:
generating a third ATVEF announcement including the first identifying information and third non-identifying information; and
sending the third ATVEF announcement.

24. The method of claim 23 further comprising:
including in the first ATVEF announcement a first version identifier;
including in the second ATVEF announcement a second version identifier indicating that the second ATVEF announcement supercedes the first ATVEF announcement; and
including in the third ATVEF announcement a third version identifier indicating that the third ATVEF announcement supercedes the second ATVEF announcement.

25. An apparatus comprising:
a preemption controller;
an announcement generator coupled to the preemption controller and adapted to generate a first announcement including first identifying information and, under control of the preemption controller, a second announcement including the first identifying information;
a content switch coupled to the preemption controller and having an input for receiving a first content item and a second content item and adapted to output the first content item absent control of the preemption controller, and to output the second content item under control of the preemption controller;
an output mechanism coupled to the announcement generator and the content switch for sending the first announcement, the first content item, the second announcement, and the second content item.

26. The apparatus of claim 25 further comprising:
a trigger switch coupled to the preemption controller and having an input for receiving a first switch item and a second switch item and adapted to output the first switch item absent control of the preemption controller, and to output the second switch item under control of the preemption controller; and
wherein the output mechanism is further coupled to the trigger switch for sending the first trigger item and the second trigger item.

27. The apparatus of claim 26 further comprising:
a content store coupled to the input of the content switch to provide the first and second content items; and
a trigger store coupled to the input of the trigger switch to provide the first and second trigger items.

28. The apparatus of claim 27 further comprising:
an A/V store and sender coupled to provide audio/visual content to be sent by the output mechanism.

29. The apparatus of claim 28 wherein the apparatus comprises an ATVEF sender, the first and second trigger items comprise ATVEF triggers, the first and second content items comprise ATVEF content, and the announcements comprise ATVEF announcements.

30. The apparatus of claim 29 wherein the first identifying information comprises a multicast port and address.

31. The apparatus of claim 30 wherein the first identifying information further comprises additional identifying information which associates the first announcement with the first trigger item and the first content item.

32. The apparatus of claim 30 wherein the first announcement further comprises non-identifying information, and the second announcement further comprises non-identifying information, wherein at least a subset of the non-identifying information of the second announcement is different than a corresponding subset of the non-identifying information of the first announcement.

33. A method for a sender to preempt a receiver, the receiver configured to select between competing presentations based on an announcement stream containing announcements which provide identifying information about each of the data streams, the method comprising the sender:
sending in the announcement stream a first announcement including first identifying information;
sending a first presentation which is associated by the first identifying information with the first announcement;
copying the first identifying information into a second announcement;
sending in the announcement stream the second announcement; and
sending a second presentation which is associated by the first identifying information with the second announcement.

34. The method of claim 33 further comprising the sender:
including in the first announcement first non-identifying information;
including in the second announcement second non-identifying information which is not identical to the first non-identifying information.

35. The method of claim 34, wherein the receiver is further configured to watch for announcements having a same identifying information as that of a prior announcement for an already-accepted presentation and to accept and utilize such announcements if they bear a version identifier greater than that of the prior announcement, the method further comprising the sender:
including in the first announcement a first version identifier; and
including in the second announcement a second version identifier greater than the first version identifier.

36. The method of claim 35 further comprising the sender:
sending a plurality of variants of the first announcement;
sending a plurality of variants of the first presentation, each corresponding to a respective variant of the first announcement;
sending a plurality of variants of the second announcement; and
sending a plurality of variants of the second presentation, each corresponding to a respective variant of the second announcement.

37. The method of claim 36 wherein variants of a presentation differ in their required transmission bandwidth.

38. The method of claim 36 wherein variants of a presentation differ in their language.

39. The method of claim 36 wherein variants of a presentation differ in their cache size requirement.

40. The method of claim 35 wherein the presentations comprise audio content.

41. The method of claim 40 wherein the presentations further comprise video content.

42. The method of claim 41 wherein the announcements comprise ATVEF announcements and the presentations comprise ATVEF presentations.

43. An article of manufacture comprising:
a machine-accessible medium including instructions that, when executed by a machine, cause the machine to perform the method of claim 1.

44. The article of manufacture of claim 43 further comprising:
instructions that, when executed by the machine, cause the machine to perform the method of claim 8.

45. An article of manufacture comprising:
a machine-accessible medium including instructions that, when executed by a machine, cause the machine to perform the method of claim 9.

46. The article of manufacture of claim 45 further comprising:
instructions that, when executed by the machine, cause the machine to perform the method of claim 19.

47. An article of manufacture comprising:
a machine-accessible medium including instructions that, when executed by a machine, cause the machine to perform the method of claim 33.

48. The article of manufacture of claim 47 further comprising:
instructions that, when executed by the machine, cause the machine to perform the method of claim 35.

49. The article of manufacture of claim 48 further comprising:
instructions that, when executed by the machine, cause the machine to perform the method of claim 36.
